(19) United States
(12) Patent Application Publication
(10) Pub. No.: US 2014/0272124 A1
(43) Pub. Date: Sep. 18, 2014

(54) Coating Systems and Methods for Countertops

(71) Applicant: Homax Products, Inc., Bellingham, WA (US)

(72) Inventors: John Kordosh, Chula Vista, CA (US); Jane D. Wasley, Bellingham, WA (US); Randal W. Hanson, Bellingham, WA (US)

(73) Assignee: Homax Products, Inc., Bellingham, WA (US)

(21) Appl. No.: 14/207,133

(22) Filed: Mar. 12, 2014

Related U.S. Application Data
(60) Provisional application No. 61/780,946, filed on Mar. 13, 2013.

(51) Int. Cl. B05D 3/00

(52) U.S. Cl. CPC B05D 3/002
USPC 427/140; 118/44

(57) ABSTRACT

A method of forming a restored countertop surface on an existing countertop surface comprises the step of applying discrete portions of a secondary material onto a base coat formed of uncured base material. The base material and the secondary material are formulated such that the secondary material does not mix with the base material and a visual appearance of the secondary material is different from that of the base material. At least one of the base material and the secondary material harden to form the restored countertop surface.

### RELATED APPLICATIONS

This application (Attorney's Ref. No. P217850) claims benefit of U.S. Provisional Application Ser. No. 61/780,946 filed Mar. 13, 2013, the contents of which are incorporated herein by reference.

### TECHNICAL FIELD

The present invention relates to coating systems and methods and, more particularly, to coating systems for and methods of forming a new countertop surface on existing countertop structure.

### SUMMARY

The present invention may be embodied as a method of forming a restored countertop surface on an existing countertop surface comprising the following steps. The existing countertop surface is prepared to form a prepared countertop surface. Base material is applied on the prepared countertop surface to form a base coat. Before the base material is allowed to set, discrete portions of a secondary material are applied onto the uncured base coat. The base material and the secondary material are formulated such that the secondary material does not mix with the base material and a visual appearance of the secondary material is different from that of the base material. At least one of the base material forming the base coat and the discrete portions of the secondary material harden to form the restored countertop surface.

The present invention may also be embodied as a system for forming a restored countertop surface on an existing countertop surface comprising a tool for abrading the existing countertop surface, base material, secondary material, and first and second applicators. The tool is used to form a prepared countertop surface. The base material and the secondary material are formulated such that the secondary material does not mix with the base material and a visual appearance of the secondary material is different from that of the base material. The first applicator applies the base material on the prepared countertop surface to form a base coat. The second applicator applies discrete portions of the secondary material onto the base coat before the base material is allowed to set. At least one of the base material forming the base coat and the discrete portions of the secondary material hardens to form the restored countertop surface.

### BRIEF DESCRIPTION OF THE DRAWINGS

FIG. 1 is a side elevation view of a step of preparing an original counter structure prior to the formation of a first example supplemental surface layer on the original counter structure;

FIG. 2 is a side elevation view of a step of forming a base portion of the first example supplemental surface layer on the original counter structure;

FIG. 3 is a side elevation view of a step of forming a secondary portion of the first example supplemental surface layer on the original counter structure;

FIG. 4 is a side elevation view depicting the first example supplemental surface layer of a second example restored counter structure;

FIG. 5 is a top plan view depicting a first appearance associated with the first example supplemental surface layer of the first example restored counter structure;

FIG. 6 is a side elevation view of a step of preparing an original counter structure prior to the formation of a second example supplemental surface layer on the original counter structure;

FIG. 7 is a side elevation view of a step of forming a base portion of the second example supplemental surface layer on the original counter structure;

FIG. 8 is a side elevation view of a step of forming a secondary portion of the second example supplemental surface layer on the original counter structure;

FIG. 9 is a side elevation view depicting the second example supplemental surface layer of a second example restored counter structure; and

FIG. 10 is a top plan view depicting a second appearance associated with the second first example supplemental surface layer of the second example restored counter structure.

### DETAILED DESCRIPTION

Referring initially to FIGS. 1-5 of the drawing, depicted therein is a first example restored counter structure 20 of the present invention and a method of forming the first example counter structure. The first example restored counter structure 20 comprises or incorporates an original counter structure 22.

The original counter structure 22 comprises a substrate 24 and an original surface layer 26. The substrate 24 is typically an inexpensive, stable, and flat material such as plywood or medium density fiber (MDF) board or high density fiber (HDF) board. The original surface layer 26 is typically an inexpensive, durable, and decorative material such as high-pressure laminates made of plastic (e.g., Formica or Arborite).

The present invention is of particular importance as a system or method of changing an appearance of an original surface layer, such as the example original surface layer 26, formed of high-pressure laminate material, and that application of the invention will be discussed herein in detail. However, the principles of the present invention may be applied to counter structures comprising only a substrate such as the example substrate 24 with other types of original surface layers such as coatings (e.g., paint) or solid surface plastic materials (e.g., Corian) or to substrates without an original surface layer.

As perhaps best shown in FIG. 4 of the drawing, the restored counter structure 20 comprises a new surface layer 30 formed on the original counter structure 22. The new surface layer 30 comprises a base portion 32 and a secondary portion 34. The base portion 32 and secondary portion 34 remain visually distinct from each other as perhaps best shown in FIG. 5 of the drawing. However, as perhaps best shown in FIG. 4, the base portion 32 and secondary portion 34 define a new surface 36 that is substantially flat and even in the example restored counter structure 20.

Referring now to FIGS. 1-3 of the drawing, one example method or process of forming the restored counter structure 20 will now be described in detail.

As shown in FIG. 1, the original surface layer 26 of the original counter structure 22 defines an original surface 40. In a first step of the process of forming the restored counter structure 20, the original surface 40 is abraded using a sander 42 or other hand or power tool to obtain a roughened surface 44. The roughened surface 44 is then cleaned such that it is free of contaminates such as oil and dust.

FIG. 2 illustrates a second step of forming the restored counter structure 20. The base portion 32 is formed from base material 50 applied using a base applicator 60. The example base applicator 60 comprises a roller 62 provided with a handle assembly 64 to facilitate handling of the roller 62. The base applicator 60 applies the base material 50 in a thin, even, smooth coat. As an alternative to the roller 62, the base applicator 60 may be formed by brushing, wiping, or spraying the base material 50 onto the original surface 40. Spraying may be accomplished by an airless or entrained air sprayer or by using an aerosol dispensing system. The roughened surface 44 formed during the first step depicted in FIG. 1 facilitates bonding of the base material 50 forming the base layer 32 to the original surface 40.

Before the base material 50 is allowed to dry, cure, set, or otherwise harden, a third step of forming the restored counter structure 20 is performed as depicted in FIG. 3. In this third step, the secondary portion 34 of the comprising secondary material 70 is formed on base material 50 using a secondary applicator 80. The example secondary applicator 80 comprises an aerosol system 82 capable of forming a spray 84 of the secondary material. In particular, the spray 84 comprises droplets of the secondary material 70 in wet or uncured form that are deposited onto the wet or uncured base layer 32 to form the secondary portion 34 of the new surface layer 30. Alternatives to the aerosol system 82 include an airless sprayer, an entrained air sprayer, or the use of a brush or the like to flick droplets of the secondary material 70 onto the wet or uncured base layer 32.

The base material 50 and the secondary material 70 are formulated such that, when the secondary material 70 is deposited onto the base material 50 when both are wet or uncured, the secondary material 70 does not mix with the base material 50. Accordingly, the secondary portions 34 formed by the secondary material 70 are distinct from the base portion 32 formed by the base material 50.

Typically, the base material 50 and the secondary material 70 will be formulated to be visually different such that the secondary portions 34 stand out from a background field established by the base portion 32. As examples, the base material 50 and secondary material 70 may contain different additives such as stone, glass, pigment, or other materials that affect a visual appearance of the base material 50 and secondary material 70 when they dry, cure, or set to form the base portion 32 and the secondary portion 34.

In one form of the invention, the base material 50 and secondary material 70 are formulated such that the droplets of the secondary material 70 forming the secondary portion 34 do not stand proud of the smooth, even coat of base material 50 forming the base portion 32. Accordingly, the new surface 36 defined by the new surface layer 30 is substantially flat. A substantially flat surface 36 is normally desirable for a counter structure.

However, the present invention may be implemented using a base material 50 and secondary material 70 formulated and/or applied such that the secondary portion 34 forms a bumpy, textured new surface that is not smooth like the example new surface layer 30. For example, if the base material 50 is substantially or completely dried, set, or cured before the application of the secondary material 70, the secondary portion 34 may not penetrate the base portion such that the new surface 36 is not substantially flat.

The example base material 50 and secondary material 70 are formulated using substantially the same solvent and binder such that the new surface layer 30 is substantially consistent. Only the visually perceptible additives of the base material 50 and secondary material 70 will typically differ in this case. However, different solvents and binders may be used so long as the solvents and binders are compatible with each other. The solvent used in the secondary material 70 should not adversely affect the drying, setting, or curing of the binder forming the base material 50. The binder of the secondary material 70 should, in any event, be capable of bonding to the base portion 32 formed by the base material 50.

The example base material 50 and secondary material 70 are or may be formulated the same, and a generic example formulation of the base material 50 and secondary material 70 is set forth in following Table A-1. In Table A-1, quantities of the components of the formulation, other than the universal colorant(s), are combined to form a concentrate using first and second ranges as a percentage by weight of a concentrate of the base material 50 or the secondary material 70. The universal colorant is added to the concentrate as required to obtain a desired color.

TABLE A-1

| | First | Second |
|---|---|---|
| Function | Range | Range |
| Modified alkyd resin 50% solids | 40-50% | 20-60% |
| Anti-settle agent | 0-1% | 0-2% |
| Dispersing agent | 0-1% | 0-2% |
| White pigment Titanium Dioxide | 20-30% | 10-40% |
| Silica flatting agent | 3-5% | 0-10% |
| Metallic drier(s) | 0-1% | 0-0.3% |
| Slow evaporating solvent 1 | 5-10% | 0-15% |
| Slow evaporating solvent 2 | 0-2% | 0-5% |
| Anti-skinning agent | 0-.5% | 0-1% |
| Polysiloxane slip aid | 0-.5% | 0-1% |
| 800 nm Al2O3 particle | 0-5% | 0-10% |
| Silane adhesion promoter | 0-.2% | 0-1% |
| Slow-evaporating solvent 3 | 0-5% | 0-10% |
| Medium-evaporating solvent 1 | 0-10% | 0-20% |
| Medium-evaporating solvent 2 | 0-5% | 0-20% |
| Universal colorant tint(s) | as needed | as needed |

A specific example formulation of the base material 50 and secondary material 70 is set forth in following Table A-2. Again, the quantities of the components of the formulation in Table A-2, except for the colorant(s), are combined to form a concentrate according to the example and first and second ranges as a percentage by weight of the concentrate. The universal colorant is added to the concentrate as required to obtain a desired color.

TABLE A-2

| Component | Function | Example |
|---|---|---|
| Epitex 183-E (US | Base resin-epoxy ester | 42.48% |
| Polymers) | | |
| Suspeno 201-X (Poly- | Anti-settle agent, helps suspend | 0.73% |
| Resyn) | pigments | |
| Disperbyk 108 (Byk | Dispersing aid | 0.25% |
| Chemie) | | |
| TiO₂-CR 828 (Titanium | White pigment | 21.24% |
| Dioxide) | | |
| Syloid 74 | Amorphous silica flatting agent | 4.75% |
| Borchi Oxy-Coat | Iron-based drier | 0.17% |
| Dowanol DPM | Slow-evaporating solvent | 9.10% |
| Hi Sol 15 | Slow-evaporating solvent | 0.83% |
| Exkin #2 (OMG) | Anti-skinning agent | 0.37% |
| Byk 323 | Polysiloxane additive for flow & | 0.40% |
| | level, slip | |
| AL-2825 (Nanophase, | 800 nm Al2O3 particle-scratch | 1.99% |
| Inc.) | resistance | |
| Silane Z-6020 (Dow | Adhesion-promoting additive | 0.10% |
| Corning) | | |
| Dowanol DPM | Slow-evaporating solvent | 2.37% |
| Downaol PM Acetate | Medium-evaporating solvent | 10.01% |
| Dowanol PM | Medium-evaporating solvent | 5.23% |
| Universal colorant tint(s) | | as needed |

As depicted in FIG. 3, the example secondary material 70 is dispensed using an aerosol system 82. In this case, the concentrate described in Table B-1 will be combined within the aerosol system 82 with a propellant such as Dimethyl Ether or a low molecular weight hydrocarbon propellant compatible with the base resin (modified alkyd resin.) In this case, the concentrate material and the propellant will be mixed according to the following Table B-1.

TABLE B-1

| | | First | Second |
|---|---|---|---|
| Component | Function | Range | Range |
| Concentrate from table A-2 | Coating material | 65-75% | 50-85% |
| Dimethyl Ether | Propellant | 25-35% | 15-50% |

Turning now to FIGS. 6-10 of the drawing, depicted therein is a second example restored counter structure 120 of the present invention and a method of forming the second example counter structure. The second example restored counter structure 120 comprises or incorporates an original counter structure 122.

The original counter structure 122 comprises a substrate 124 and an original surface layer 126. The substrate 124 is typically an inexpensive, stable, and flat material such as plywood or medium density fiber (MDF) board or high density fiber (HDF) board. The original surface layer 126 is typically an inexpensive, durable, and decorative material such as high-pressure laminates made of plastic (e.g., Formica or Arborite).

The present invention is of particular importance as a system or method of changing an appearance of an original surface layer, such as the example original surface layer 126, formed of high-pressure laminate material, and that application of the invention will be discussed herein in detail. However, the principles of the present invention may be applied to counter structures comprising only a substrate such as the example substrate 124 with other types of original surface layers such as coatings (e.g., paint) or solid surface plastic materials (e.g., Corian) or to substrates without an original surface layer.

As perhaps best shown in FIG. 9 of the drawing, the restored counter structure 120 comprises a new surface layer 130 formed on the original counter structure 122. The new surface layer 130 comprises a base portion 132 and a secondary portion 134. The base portion 132 and secondary portion 134 remain visually distinct from each other as perhaps best shown in FIG. 10 of the drawing. However, as best shown in FIG. 9, the base portion 132 and secondary portion 134 define a new surface 136 that is substantially flat and even in the example restored counter structure 120.

Referring now to FIGS. 6-8 of the drawing, one example method or process of forming the restored counter structure 120 will now be described in detail.

As shown in FIG. 6, the original surface layer 126 of the original counter structure 122 defines an original surface 140. In a first step of the process of forming the restored counter structure 120, the original surface 140 is abraded using a sander 142 or other hand or power tool to obtain a roughened surface 144. The roughened surface 144 is then cleaned such that it is free of contaminates such as oil and dust.

FIG. 7 illustrates a second step of forming the restored counter structure 120. The base portion 132 is formed from base material 150 applied using a base applicator 160. The example base applicator 160 comprises a roller 162 provided with a handle assembly 164 to facilitate handling of the roller 162. The base applicator 160 applies the base material 150 in a thin, even, smooth coat. As an alternative to the roller 162, the base applicator 160 may be formed by brushing, wiping, or spraying the base material 150 onto the original surface 140. Spraying may be accomplished by an airless or entrained air sprayer or by using an aerosol dispensing system. The roughened surface 144 formed during the first step depicted in FIG. 6 facilitates bonding of the base material 150 forming the base layer 132 to the original surface 140.

Before the base material 150 is allowed to dry, cure, set, or otherwise harden, a third step of forming the restored counter structure 120 is performed as depicted in FIG. 8. In this third step, the secondary portion 134 of the comprising secondary material 170 is formed on base material 150 using a secondary applicator 180. The example secondary applicator 180 comprises a rag roller 182 provided with a handle assembly 184 to facilitate handling of the roller 182. The secondary applicator 180 comprising a rag roller 182 applies the secondary material 170 in an irregular, splotch manner. In particular, the secondary material 170 is applied by the rag roller 182 in wet or uncured form onto the wet or uncured base layer 132 to form the secondary portion 134 of the new surface layer 130. Instead of fine droplets that result in a fine pattern of small secondary portions 34 as shown FIG. 5, the use of a rag roller 182 yields a less fine pattern of larger secondary portions 134 as shown in FIG. 10. While the pattern in FIG. 5 may be formed to yield the look of fine grain stone or concrete, the pattern in FIG. 10 may be formed to yield the look of large grain stone such as marble.

The base material 150 and the secondary material 170 are formulated such that, when the secondary material 170 is deposited onto the base material 150 when both are wet or uncured, the secondary material 170 does not mix with the base material 150. Accordingly, the secondary portions 134 formed by the secondary material 170 are distinct from the base portion 132 formed by the base material 150.

Typically, the base material 150 and the secondary material 170 will be formulated to be visually different such that the secondary portions 134 stand out from a background field established by the base portion 132. As examples, the base material 150 and secondary material 170 may contain different additives such as stone, glass, pigment, or other materials that affect a visual appearance of the base material 150 and secondary material 170 when they dry, cure, or set to form the base portion 132 and the secondary portion 134.

In one form of the invention, the base material 150 and secondary material 170 are formulated such that the droplets of the secondary material 170 forming the secondary portion 134 do not stand proud of the smooth, even coat of base material 150 forming the base portion 132. Accordingly, the new surface 136 defined by the new surface layer 130 is substantially flat. A substantially flat surface 136 is normally desirable for a counter structure.

However, the present invention may be implemented using a base material 150 and secondary material 170 formulated and/or applied such that the secondary portion 134 forms a bumpy, textured new surface that is not smooth like the example new surface layer 130. For example, if the base material 150 is substantially or completely dried, set, or cured before the application of the secondary material 170, the secondary portion 134 may not penetrate the base portion such that the new surface 136 is not substantially flat.

The example base material 150 and secondary material 170 may be formulated in the same basic manner as the example base material 50 and secondary material 70 described above. However, while the example secondary material 70 was formulated to be combined with a propellant in an aerosol system, the example secondary material 170 is to be applied using the rag roller 182 in a concentrate form and need not to be formulated to be combined with a propellant.

What is claimed is:

1. A method of forming a restored countertop surface on an existing countertop surface, comprising the steps of:
preparing the existing countertop surface to form a prepared countertop surface;
applying base material on the prepared countertop surface to form a base coat;
before the base material is allowed to set, applying discrete portions of a secondary material onto the uncured base coat, where the base material and the secondary material are formulated such that the secondary material does not mix with the base material, and a visual appearance of the secondary material is different from that of the base material; and
allowing at least one of the base material forming the base coat and the discrete portions of the secondary material to harden to form the restored countertop surface.

2. A method as recited in claim 1, in which the step of preparing the existing countertop surface comprises the step of abrading the existing countertop surface.

3. A method as recited in claim 1, in which the step of preparing the existing countertop surface comprises the step of cleaning the existing countertop surface.

4. A method as recited in claim 2, in which the step of preparing the existing countertop surface further comprises the step of cleaning the prepared countertop surface.

5. A method as recited in claim 1, in which the step of applying the base material comprises the step of mechanically applying a base material to the prepared countertop surface.

6. A method as recited in claim 1, in which the step of applying the base material comprises the step of spraying a base material onto the prepared countertop surface.

7. A method as recited in claim 1, in which the step of applying the secondary material comprises the step of mechanically applying the secondary material onto the base coat.

8. A method as recited in claim 1, in which the step of applying the secondary material comprises the step of spraying the secondary material onto the base coat.

9. A method as recited in claim 7, in which the step of applying the secondary material comprises the step of mechanically applying the secondary material onto the base coat.

10. A method as recited in claim 8, in which the step of applying the secondary material comprises the step of mechanically applying the secondary material onto the base coat.

11. A method as recited in claim 7, in which the step of applying the secondary material comprises the step of spraying the secondary material onto the base coat.

12. A method as recited in claim 8, in which the step of applying the secondary material comprises the step of spraying the secondary material onto the base coat.

13. A method as recited in claim 1, in which restored countertop surface is substantially flat.

14. A system for forming a restored countertop surface on an existing countertop surface, comprising:
a tool for abrading the existing countertop surface to form a prepared countertop surface;
a base material;
a secondary material, where the base material and the secondary material are formulated such that
the secondary material does not mix with the base material, and
a visual appearance of the secondary material is different from that of the base material;
a first applicator for applying the base material on the prepared countertop surface to form a base coat; and
a second applicator for applying discrete portions of the secondary material onto the base coat before the base material is allowed to set; whereby
at least one of the base material forming the base coat and the discrete portions of the secondary material hardens to form the restored countertop surface.

15. A system as recited in claim 14, in which the first applicator mechanically applies the base material to the prepared countertop surface.

16. A system as recited in claim 14, in which the first applicator sprays the base material onto the prepared countertop surface.

17. A system as recited in claim 14, in which the second applicator mechanically applies the secondary material onto the base coat.

18. A system as recited in claim 14, in which the second applicator sprays the secondary material onto the base coat.

19. A system as recited in claim 17, in which the second applicator mechanically applies the secondary material onto the base coat.

20. A system as recited in claim 17, in which the second applicator sprays the secondary material onto the base coat.

21. A system as recited in claim 18, in which the second applicator mechanically applies the secondary material onto the base coat.

22. A system as recited in claim 18, in which the second applicator sprays the secondary material onto the base coat.
